(19) United States
(12) Patent Application Publication
(10) Pub. No.: US 2012/0151415 A1
(43) Pub. Date: Jun. 14, 2012

(54) METHOD FOR PROVIDING A USER INTERFACE USING MOTION AND DEVICE ADOPTING THE METHOD

(76) Inventors: Yong-Gook Park, Yongin-si (KR); Han-Chul Jung, Songpa-gu (KR); Min-Ku Park, Seongnam-si (KR); Tae-Young Kang, Uljeongbu-si (KR); Bo-Min Kim, Guro-gu (KR); Hyun-Jin Kim, Seocho-gu (KR)

(21) Appl. No.: 13/392,364

(22) PCT Filed: Aug. 24, 2010
(86) PCT No.: PCT/KR10/05662

§ 371 Date: Feb. 24, 2012

(30) Foreign Application Priority Data
Aug. 24, 2009 (KR) 10-2009-0078367
Aug. 24, 2009 (KR) 10-2009-0078369

(51) Int. Cl. G06F 3/033; G06F 3/048

(52) U.S. Cl. 715/835; 715/863

(57) ABSTRACT

A method for providing a User Interface (UI), in which a common function is mapped to a plurality of motions, and a device adopting the method is provided. The method includes performing a function commonly mapped to a plurality of motions when a user motion falls within any one of the plurality of motions. Thus, as a plurality of motions for instructing a specific function exists, a user may input a familiar or desired motion, to thereby enable the user to input a command for a function in a more convenient and free manner.

### PRIORITY

This application claims priority under 35 U.S.C. §119(a) to KR 10-2009-0078367 and KR 10-2009-0078369, both filed with the Korean Patent Office on Aug. 24, 2009, and to International Patent Application Serial No. PCT/KR2010/005662 filed Aug. 24, 2010, the entire disclosure of each of which is incorporated herein by reference.

### BACKGROUND

1. Field of the Invention

The present invention relates generally to a method of providing a User Interface (UI) and a device adopting the method and, more particularly, to a method of providing a UI for entering a command to execute a function desired by a user and a device adopting the method.

2. Description of the Art

User Interfaces (UIs), which connect devices and users, have been developed as means for users to conveniently enter desired commands.

UIs not only allow users to enter commands but also provide users with various entertainment features, and recent trends in the development of UIs increasingly tend to be directed toward the latter because of ever-increasing user preferences for products equipped with UIs that can provide additional entertainment features.

Therefore, a method is needed to provide a UI that not only can make it easier to enter various user commands but also can cause amusement for users while using devices.

### SUMMARY OF THE INVENTION

The present invention provides a method of providing a User Interface (UI) to, in response to a user's motion matching any one of a plurality of motions, execute a function mapped to the plurality of motions, and a device adopting the method.

The present invention also provides a method of providing a UI that executes a function mapped to a motion or outputs an effect associated with the function based on the size of the motion, and a device adopting the method.

According to an aspect of the present invention, there is provided a method of providing a user interface (UI), the method including identifying a user's motion; and in response to the identified motion coinciding with any one of a plurality of motions, performing a function commonly mapped to the plurality of motions.

The performing may include performing the function while varying a visual effect that is accompanied by the performing.

Details of the visual effect may be determined based on at least one of a plurality of parameters of the identified motion.

Elements of the visual effect may correspond to a value of the at least one parameter of the identified motion.

Details of the visual effect may be determined based on a content item to which the visual effect is to be applied or the content of a background.

The visual effect may include an animation effect.

A state of mapping the function and the plurality of motions may vary from one application to another application.

The performing may include varying at least one of an audio effect and a tactile effect that is accompanied by the performing depending on the type of the identified motion.

The method may also include, in response to a size of the identified motion exceeding a first threshold, performing the function and, in response to whether the size of the identified motion exceeds the first threshold, outputting an effect that is relevant to the function.

The method may also include, in response to a value of at least one of a plurality of parameters of the identified motion exceeding a threshold, determining whether the size of the identified motion exceeds the first threshold.

The effect relevant to the function may include a visual effect that helps the user intuitively recognize the function.

The outputting may include outputting different visual effects for motions of different sizes.

The outputting may include outputting the effect in response to whether the size of the identified motion determined not to exceed the first threshold but to exceed the second threshold, which is less than the first threshold.

When there are multiple functions that can be performed in response to a determination of whether the size of the identified motion exceeds the first threshold, the outputting may include outputting visual effects that are relevant to the multiple functions together when the size of the identified motion is determined to not exceed the first threshold.

When there are multiple functions that can be performed in response to a determination of whether the size of the identified motion exceeds the first threshold, the performing may include performing a function that is selected from among the multiple functions by the user while making the identified motion, in response to the determination that the size of the identified motion exceeds the first threshold.

The selected function may correspond to a function relevant to an icon selected by the user.

The effect may include at least one of an audio effect and a tactile effect.

According to another aspect of the present invention, there is provided a device including a sensing unit which senses a user's motion and a control unit which, in response to the sensed motion coinciding with any one of a plurality of motions, controls a function commonly mapped to the plurality of motions to be performed.

The controller may control the function to be performed while varying a visual effect that is accompanied by the performing of the function.

Details of the visual effect may be determined based on at least one of a plurality of parameters of the sensed motion.

Elements of the visual effect may correspond to a value of the at least one parameter of the sensed motion.

Details of the visual effect may be determined based on a content item to which the visual effect is to be applied or the content of a background.

The visual effect may include an animation effect.

A state of mapping the function and the plurality of motions may vary from one application to another application.

The control unit may control the function to be performed while varying at least one of an audio effect and a tactile effect that is accompanied by performing a function depending on the type of sensed motion.

The control unit may control the function to be performed in response to a size of the sensed motion exceeding a first threshold, and may output an effect that is relevant to the function in response to the size of the sensed motion not exceeding the first threshold.

The effect relevant to the function may include a visual effect that helps the user intuitively recognize the function.

The controller may control different visual effects to be output based on motions of different sizes.

The controller may control a visual effect including a movement that is proportional to the size of the sensed motion.

In a case in which there are multiple functions that can be performed in response to the size of the sensed motion exceeding the first threshold, the control unit may control visual effects that are relevant to the multiple functions to be output together in response to the size of the sensed motion not exceeding the first threshold.

In a case in which there are multiple functions that can be performed in response to the size of the sensed motion exceeding the first threshold, the control unit may control a function that is selected from among the multiple functions by the user while making the sensed motion to be performed in response to the size of the sensed motion exceeding the first threshold.

As described above, according to the present invention, in response to a user's motion coinciding with any one of a plurality of motions, it is possible to perform a predetermined function to which the plurality of motions are commonly mapped. Therefore, since there is more than one function that initiates the predetermined function, it is possible for the user to easily enter a command to perform the predetermined function with convenience.

In addition, since a visual effect varies from one motion to another motion made by the user, it is possible to provide improved entertainment features as compared to an existing UI.

Moreover, since a device may be configured to perform a function mapped to the user's motion or to output an effect relevant to the function in consideration of the size of the user's motion, it is possible for the user to easily identify the function and thus to easily enter a command with convenience, thereby allowing for enhanced user amusement while using the device.

### BRIEF DESCRIPTION OF THE DRAWINGS

The above and other aspects, features and advantages of an embodiment of the present invention will be more apparent from the following detailed description taken in conjunction with the accompanying drawings, in which:

FIGS. 1 to 4 illustrate various embodiments of the present invention;

FIG. 5 is a block diagram of a device to which the present invention can be applied;

FIG. 6 is a flowchart illustrating a method of providing a UI according to an embodiment of the present invention;

FIGS. 7 to 13 are diagrams illustrating various other embodiments of the present invention;

FIG. 14 is a diagram explaining the embodiments of FIGS. 7 to 13;and

FIG. 15 is a flowchart illustrating a method of providing a UI according to another embodiment of the present invention.

### DETAILED DESCRIPTION OF EMBODIMENTS OF THE PRESENT INVENTION

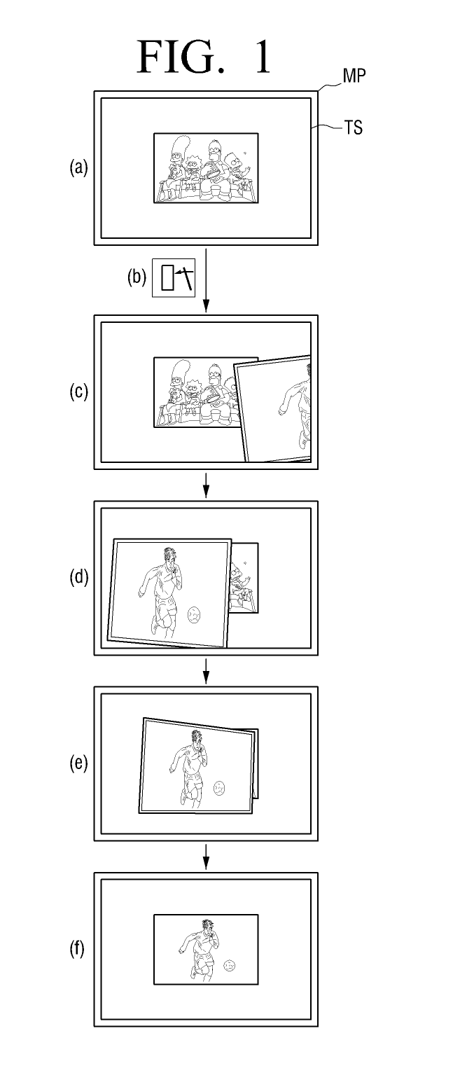

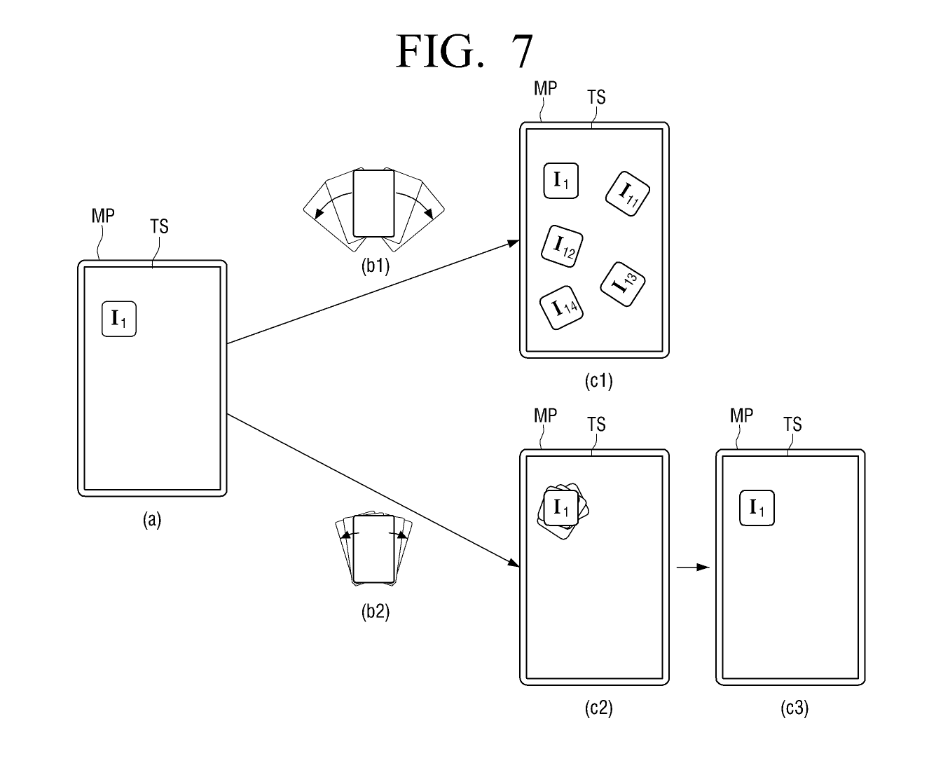

The invention is described hereinafter with reference to the accompanying drawings, in which exemplary embodiments of the invention are shown. An example of executing a function that is mapped to a plurality of motions in response to a user's motion matching any one of the plurality of motions is described with reference to FIGS. 1 to 6, and a method of providing a UI that provides different functions for motions of different sizes is described with reference to FIGS. 7 to 16.

FIG. 1(a) illustrates a mobile phone (MP) with a touch screen (TS) that displays a Graphic User Interface (GUI), with a single image displayed in the GUI.

FIG. 1(b) illustrates a ‘tip’ motion toward a right side of the MP, and FIGS. 1(c) to 1(f) illustrate gradual variations in the GUI in response to the ‘tip’ motion.

Referring to FIGS. 1(c) to 1(f), the GUI displays a visual effect in which another image, i.e. a next image, appears from the right side of the MP and falls in a zigzag manner over the current image.

In response to the detection of a ‘tip’ motion from the left side of the MP, the GUI may display a visual effect of the originally displayed or of a previous image appearing from the left side of the MP and falling in a zigzag manner over the current image.

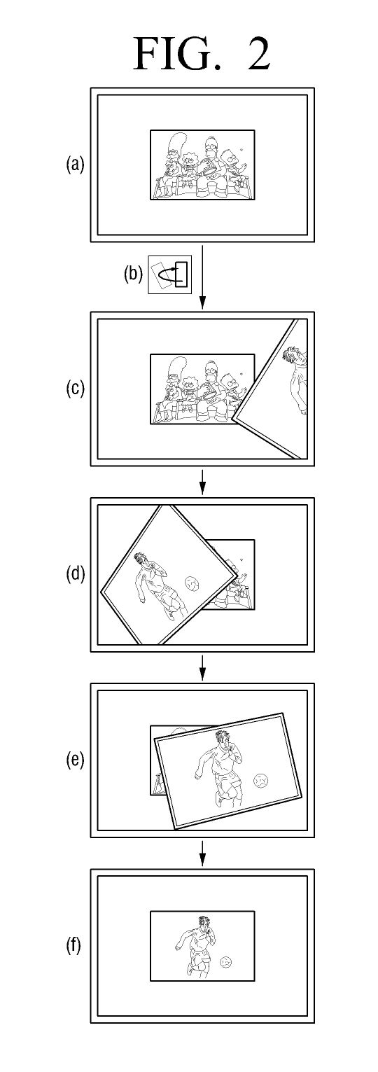

FIG. 2(a) also illustrates the MP with the TS that displays the GUI. FIG. 2(b) illustrates a ‘snap’ motion (for example, snapping the MP to the left). FIGS. 2(c) to 2(f) illustrate gradual variations in the GUI in response to the ‘snap’ motion. Referring to FIGS. 2(c) to 2(f), the GUI displays a visual effect of the next image appearing from the direction from which the ‘snap’ motion is detected, i.e., the left side of the MP, and falling in a circular motion over the current image.

In response to the detection of the ‘snap’ motion from the left side of the MP, the GUI may display a visual effect of the previous image appearing from the right side of the MP and falling in a circular motion over the current image.

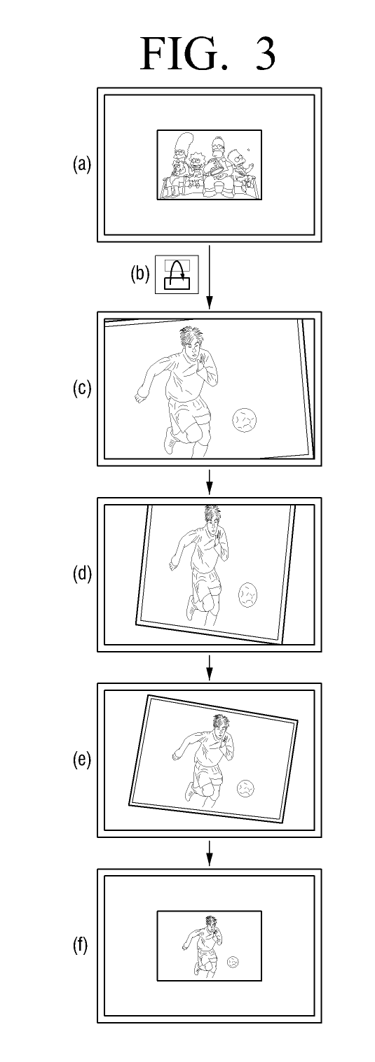

FIG. 3(a) illustrates MP with a touch screen TS displaying a GUI. FIG. 3(b) illustrates a ‘bounce’ motion (for example, an up and down motion of the MP). FIGS. 3(c) to 3(f) illustrate gradual variations in the GUI in response to the ‘bounce’ motion.

Referring to FIGS. 3(c) to 3(f), the GUI displays a visual effect of the next image appearing from above the current image and falling over the current image.

In response to the user putting down the mobile terminal and then lifting it up, the GUI may display a visual effect of the previous image appearing from behind the current image and rising above the current image.

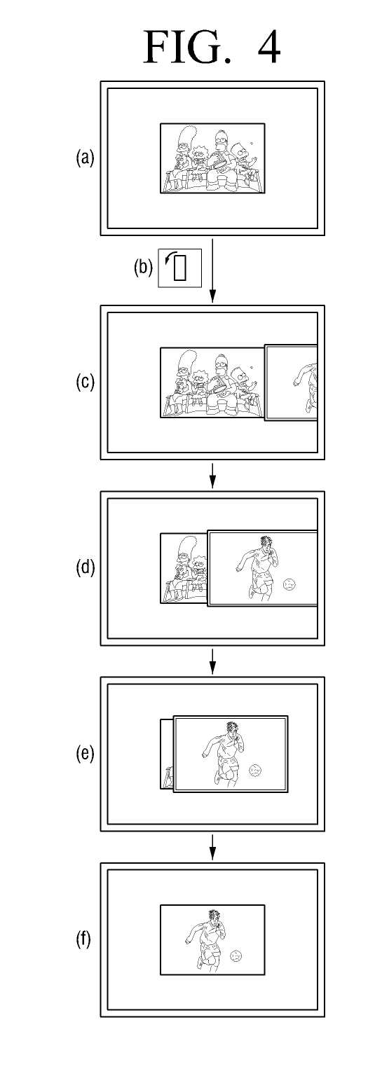

FIG. 4(a) illustrates the MP with a touch screen TS displaying a GUI. FIG. 4(b) illustrates a ‘rotate’ motion (for example, rotating the MP to the left). FIGS. 4(c) to 4(f) illustrate gradual variations in the GUI in response to the ‘rotate’ motion.

Referring to FIGS. 4(c) to 4(f), the GUI displays a visual effect of the next image appearing from the direction in which the mobile terminal is rotated, i.e., the left side of the mobile terminal, and sliding over the current image.

In response to the user rotating the mobile terminal to the right, the GUI may display a visual effect of the previous image appearing from the direction in which the mobile terminal is rotated, i.e., the left side of the mobile terminal and sliding over the current image.

In the examples illustrated in FIGS. 1 to 4, in response to a user performing one of the ‘tip’ motion (for example, tipping the right side of the mobile terminal), the ‘snap’ motion (for example, snapping the mobile terminal to the right), the ‘bounce’ motion (for example, bounding up and down the mobile terminal), and the ‘rotate’ motion (for example, rotating the mobile terminal), an image currently being displayed on a touch screen may disappear, and a subsequent image may be displayed on the touch screen.

That is, a mobile terminal may perform the same function, i.e., an image turner function, for different motions performed by the user, i.e., the ‘tip’ motion, the ‘snap’ motion, the ‘bounce’ motion and the ‘rotate’ motion, because the ‘tip’ motion, the ‘snap’ motion, the ‘bounce’ motion and the ‘rotate’ motion are all mapped to the image turner function. However, a visual effect for turning images, i.e., making a current image disappear and making a subsequent image appear, may vary from one motion to another motion performed by the user, as described herein.

Determination of Visual Effect Based on Motion Parameters

Even for motions of the same type, a visual effect may vary depending on the motion trajectory. For example, visual effects for motions of the same type may be basically similar except for certain visual elements thereof.

For example, for the ‘tip’ motion, a visual effect may be basically as illustrated in FIGS. 1(c) to 1(f). A direction in which a subsequent image to a current image appears may be determined based on the direction of a motion, which is determined by analyzing the trajectory of the motion, and the speed at which the subsequent image appears may be determined by the speed of the motion of the mobile phone, which is also determined by analyzing the trajectory of the motion.

For example, the faster the motion, the faster the subsequent image appears, and the slower the motion, the slower the subsequent image appears. That is, the speed at which the subsequent image appears may be proportional to the speed of the motion.

The degree of the shaking or the rotating of the subsequent image may be determined by the degree of a shake or a rotation involved in the motion, which is also determined by analyzing the trajectory of the motion.

For example, the greater the degree of a shake involved in the motion, the greater the degree of the shaking of the subsequent image, and the less the degree of a shake involved in the motion, the less the degree of the shaking of the subsequent image. That is, the degree of the shaking or the rotating of the subsequent image may be proportional to the degree of a shake or a rotation involved in the motion.

The width of the movement of the subsequent image may be determined based on the width of the motion, which is also determined by analyzing the trajectory of the motion.

For example, for a wider motion, a wider movement of the subsequent image results, and for a narrower motion, a narrower movement of the subsequent image results. Accordingly, the width of the movement of the subsequent image may be proportional to the width of the motion.

The details of a visual effect may be determined based on one or more parameters of a motion, for example, the direction, speed, and width of the motion and the degree of a shake (or a rotation) involved in the motion. Obviously, the details of a visual effect may also be determined based on various parameters of a motion, other than those set forth herein.

Determination of Visual Effect Based on Content of Image or GUI

The details of a visual effect that varies even for motions of the same type may be determined based on various factors, other than the motion type.

The details of a visual effect may be determined based on the content of an image. For example, for an image that is bright, small in size, light in texture, or has dynamic content, a visual effect at which a subsequent image appears, the degree to which the subsequent image shakes or rotates when appearing, and the width of the movement of the subsequent image are all set to be generated at a high speed.

On the other hand, for an image that is dark, large in size, heavy in texture, or has static content, a visual effect at which a subsequent image appears, the degree to which the subsequent image shakes or rotates when appearing, and the width of the movement of the subsequent image are all set to be generated at a low speed.

The details of a visual effect may also vary depending on the content of a GUI background screen.

For example, for a GUI background screen that is bright, small in size, light in texture, or has dynamic content, a visual effect for which the speed at which a subsequent image to a current image appears, the degree to which the subsequent image shakes or rotates when appearing, and the width of the movement of the subsequent image are all set to be high may be generated.

In the above examples, an application currently being executed in a mobile phone is assumed to be an image viewer, and thus, the UI of an image viewer is displayed on the touch screen of the mobile terminal.

For the UI of another application (such as a music player), the above described four motions may be mapped to different functions, or some of the four motions may be mapped to the same function and the other motions may be mapped to different functions.

In the above examples, a visual effect varies depending on the type of motion. In another example, an audio effect or a tactile effect that varies depending on the type of motion may be realized.

The above examples have been described with a UI provided by a mobile phone as an example. However, the present invention may also be applied to various devices, other than a mobile phone, for example, an MP3 player, a digital camera, a digital camcorder, a Portable Multimedia Player (PMP), or the like.

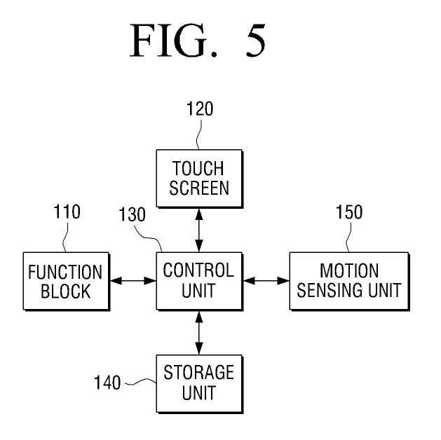

FIG. 5 is a block diagram illustrating a device to which the present invention can be applied. Referring to FIG. 5, the device includes a function block 110, a touch screen 120, a control unit 130, a storage unit 140, and a motion sensing unit 150.

The function block 110 may perform a function corresponding to the type of device. For example, when the device is a mobile phone, the function block 110 may perform making or receiving a call, sending or receiving an SMS message, and the like. For example, when the device is an MP3 player, the function block 110 may play an MP3 file.

The touch screen 120 may serve as a display unit for displaying the results of an operation performed by the function block 110 and a GUI, or may also serve as a user manipulation unit for receiving a user command.

The storage unit 140 may be a storage medium for storing various programs, content, and other data necessary for driving the function block 110 and providing a GUI.

The motion sensing unit 150 may detect a user's motion while the device is being held in the user's hand, and may transmit the results of the detection to the control unit 130 as motion sensing result data.

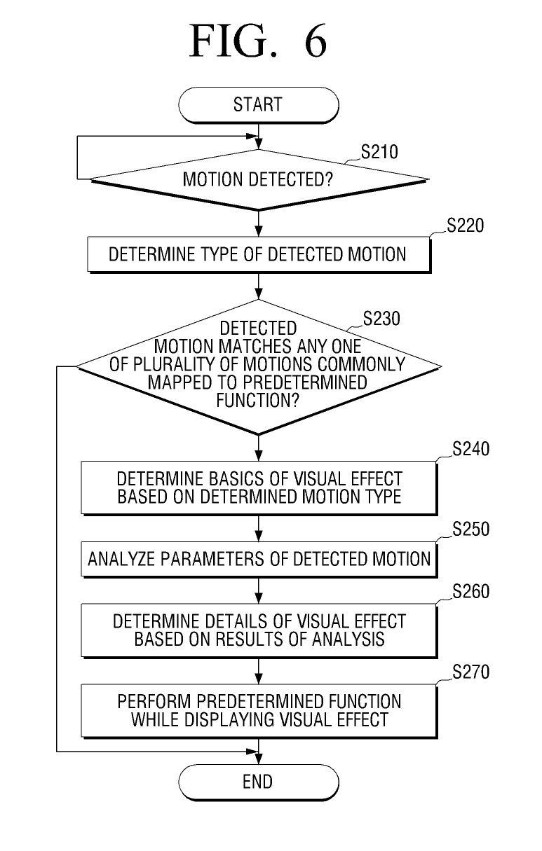

The control unit 130 may identify the type of the detected motion based on the motion sensing result data, and may analyze the parameters of the detected motion. The control unit 130 may control the function block 110 to perform a function corresponding to the detected motion along with a visual effect and may control the state of the display of a GUI on the touch screen 120. The operation of the device will hereinafter be described with reference to FIG. 6.

FIG. 6 is a flowchart illustrating a method of providing a UI according to an embodiment of the present invention.

Referring to FIG. 6, in response to the detection of the user's motion by the motion sensing unit 150 at Step 210, the control unit 130 may identify the type of the detected motion and proceed to Step 220.

In response to the detected motion coinciding with any one of a plurality of motions that are all mapped to a predetermined function at Step 230, the control unit 130 may determine the basics of a visual effect based on the identified type of the detected motion at Step 240.

For example, when an application currently being executed is an image viewer, the plurality of motions may include the ‘tip’ motion, the ‘snap’ motion, the ‘bounce’ motion, and the ‘rotate’ motion.

For example, the basics of the visual effect may include the content of an animation involved in the visual effect.

The control unit 130 may analyze the parameters of the detected motion in Step 250, and may determine the details of the visual effect based on the results of the analysis at Step 260.

For example, the parameters of the detected motion may include the direction, speed, and width of the detected motion and the degree of a shake or rotation involved in the motion. For example, the details of the visual effect may include the direction, speed and width of a movement involved in the visual effect and the degree of a shake (or a rotation) involved in the visual effect.

At Step 270, the control unit 130 may control the function block 110 to perform a function corresponding to the detected motion while controlling the touch screen 120 to display the visual effect based on the results of the determinations performed in Step 240 and Step 260.

An example of executing a function to which a plurality of motions are commonly mapped in response to the detection of a user's motion that coincides with any one of the plurality of motions has been described with reference to FIGS. 1 to 6.

An example of providing a UI that provides different functions for motions of different sizes will hereinafter be described with reference to FIGS. 7 to 16.

FIG. 7 illustrates a method of providing a UI according to a first embodiment of the present invention. FIG. 7(a) illustrates a MP with a touch screen TS that displays a GUI. Referring to FIG. 7(a), a single icon I, is displayed in the GUI.

FIG. 7(b₁) illustrates a ‘strong shake’ motion, i.e., the motion of shaking the MP heavily. FIG. 7(c₁) illustrates a variation in the GUI in response to the ‘strong shake’ motion.

Referring to FIG. 7(c₁), not only the icon I₁ but also a plurality of sub-icons I₁₁, I₁₂, I₁₃, and I₁₄ of the icon I₁ are displayed in the GUI. The sub-icons I₁₁, I₁₂, I₁₃, and I₁₄ may be displayed as being taken out from behind the icon I₁.

FIG. 7(b₂) illustrates a ‘gentle shake’ motion, i.e., the motion of shaking the MP gently. FIGS. 7(c₂) and 7(c₃) illustrate variations in the GUI in response to the ‘gentle shake’ motion.

Referring to FIGS. 7(c₂) and 7(c₃), a visual effect of the sub-icons I₁₁, I₁₂, I₁₃, and I₁₄ partially appearing from below the icon I₁ for a short duration and then readily returning into the bottom of the icon I₁ is displayed in the GUI. Accordingly, a user may intuitively recognize the sub-icons I₁₁, I₁₂, I₁₃, and 1₁₄ have failed to be removed from below the icon I₁.

Then, the user may naturally assume that a stronger shake of the MP would successfully remove the sub-icons I₁₁, I₁₂, I₁₃, and I₁₄ from behind the icon I₁ so that the sub-icons I₁₁, I₁₂, I₁₃, and I₁₄ may appear on the touch screen TS.

Removing the sub-icons I₁₁, I₁₂, I₁₃, and I₁₄ from the behind the icon I₁ and making them appear on the touch screen may be a function corresponding to a ‘shake’ motion.

Therefore, in response to a strong shake of the MP, the MP may perform the function corresponding to the ‘shake’ motion. On the other hand, in response to a gentle shake of the MP, the MP may provide a visual effect that helps the user to intuitively recognize the function corresponding to the ‘shake’ motion.

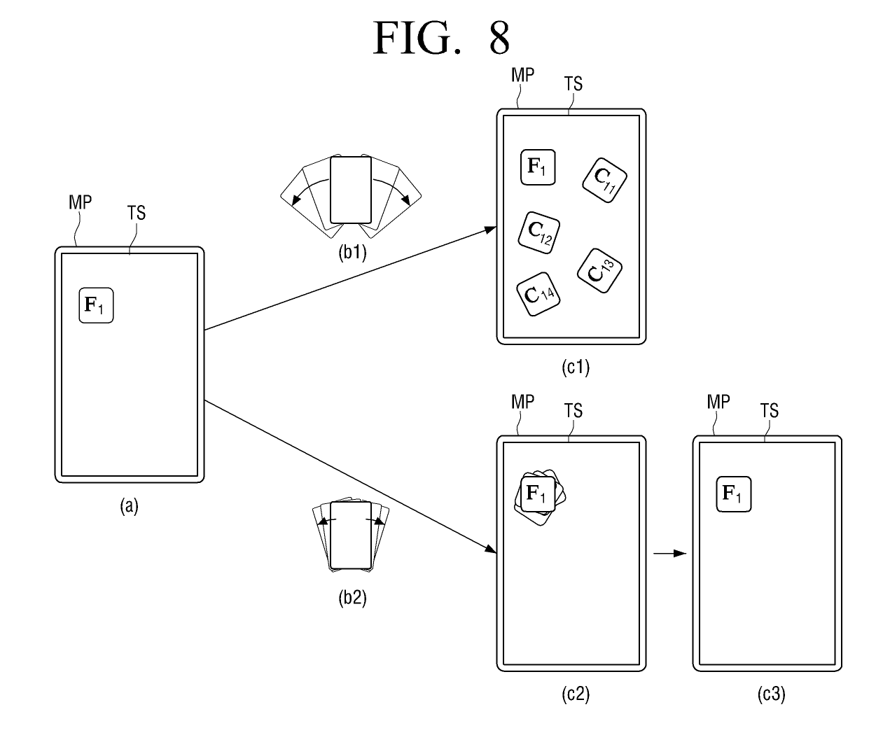

FIG. 8 illustrates a method of providing a UI according to a second embodiment of the present invention. The example illustrated in FIG. 8 is the same as the example illustrated in FIG. 7 except that a folder F₁ is initially displayed in a GUI, instead of the icon I₁, and that content items C₁₁, C₁₂, C₁₃, C₁₄ are displayed, instead of the sub-icons I₁₁, I₁₂, I₁₃, and I₁₄, in response to a ‘shake’ motion, and thus, a detailed description of the example illustrated in FIG. 8 will be omitted.

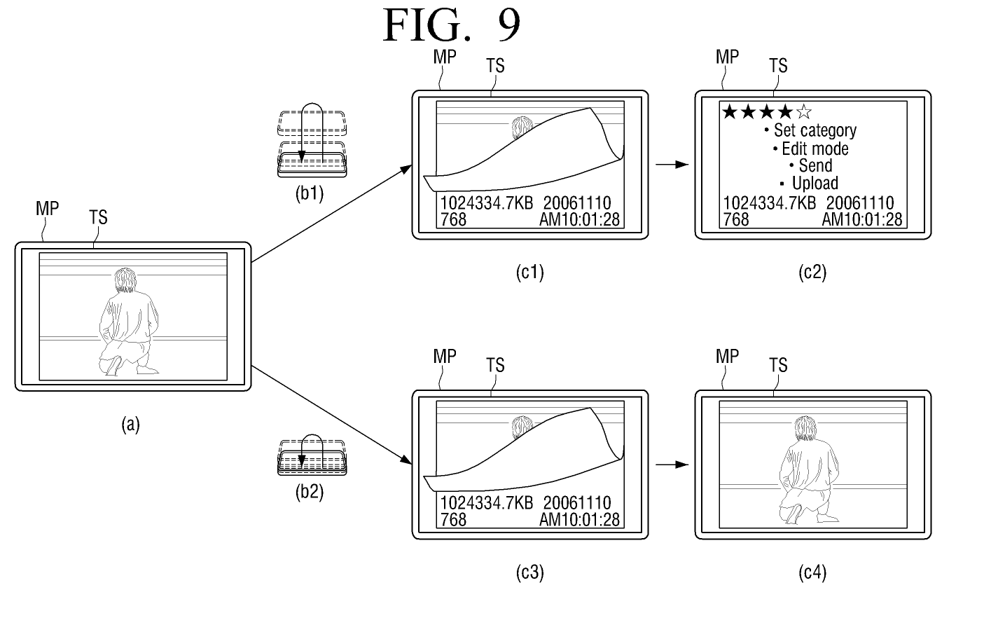

FIG. 9 illustrates a method of providing a UI according to a third embodiment of the present invention. FIG. 9(a) illustrates a MP with a touch screen that displays a GUI. Referring to FIG. 9(a), a photo is displayed in the GUI.

FIG. 9(b₁) illustrates a ‘high bounce’ motion, i.e., the motion of picking the MP up high and putting down the MP. FIGS. 9(c₁) and 9(c₂) illustrate variations in the GUI in response to the ‘high bounce’ motion.

Referring to FIGS. 9(c₁) and 9(c₂), an image of the photo being turned over may be displayed, and detailed information on the photo and a plurality of menu items may be displayed.

FIG. 9(b₂) illustrates a ‘low bounce’ motion, i.e., the motion of picking up the MP only to a lower height and putting down the MP. FIGS. 9(c₃) and 9(c₄) illustrate variations in the GUI in response to the ‘low bounce’ motion.

Referring to FIGS. 9(c₃) and 9(c₄), a visual effect of the photo trying, but failing, to be turned over may be displayed in the GUI. Accordingly, a user may intuitively recognize that the photo has failed to turn over.

Then, the user may naturally assume that a higher bounce of the MP would successfully turn over the photo so that the detailed information on the photo and the menu items may be displayed on the touch screen.

Turning over an image and displaying detailed information on the image and one or more menu items may be a function corresponding to the ‘bounce’ motion.

Therefore, in response to a high bounce of the MP, the MP may perform the function corresponding to the ‘bounce’ motion. On the other hand, in response to a low bounce of the MP, the MP may provide a visual effect that helps the user to intuitively recognize what the function corresponding to the ‘bounce’ motion is.

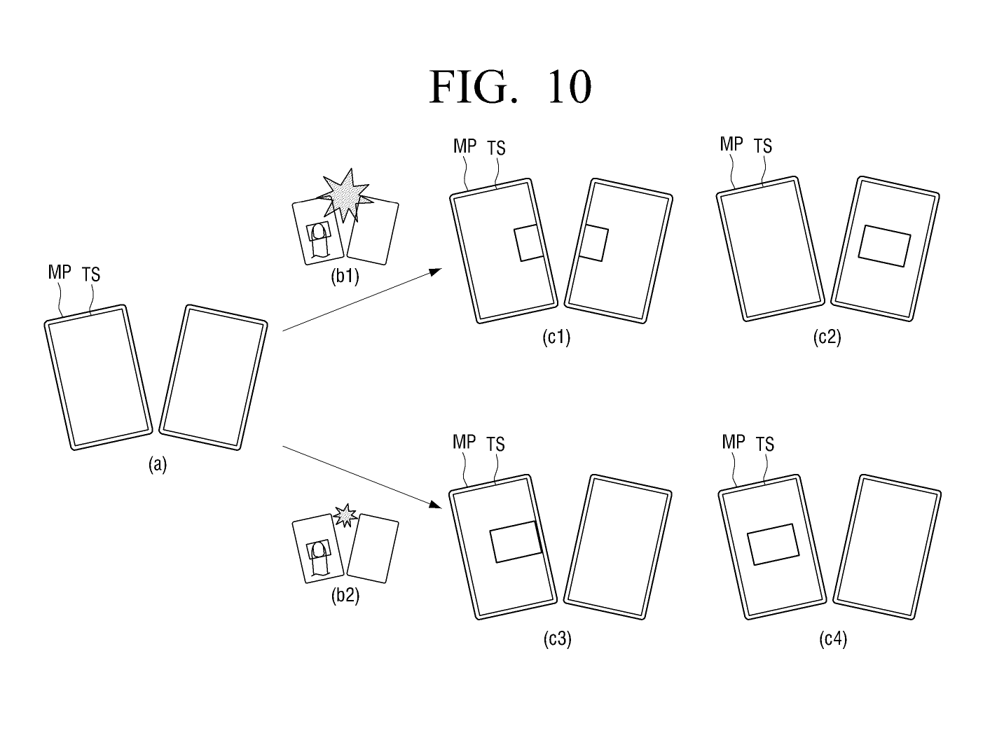

FIG. 10 illustrates a method of providing a UI according to a fourth embodiment of the present invention. FIG. 10(a) illustrates two MPs, each with a TS that displays a GUI therein. Referring to FIG. 10(a), a photo is displayed in the GUI.

FIG. 10(b₁) illustrates a ‘hard bump’ motion, i.e., the motion of tapping the MP hard against another mobile terminal. FIGS. 10(c₁) and 10(c₂) illustrate variations in the GUI in response to the ‘hard bump’ motion.

Referring to FIGS. 10(c₁) and 10(c₂), a visual effect of the photo being transferred from the MP to the other mobile phone may be displayed in the GUI, and the photo may disappear from the screen of the MP and may appear on the screen of the other mobile phone. That is, the photo may be transmitted (transferred) from the MP to the other mobile phone.

FIG. 10(b₂) illustrates a ‘gentle bump’ motion, i.e., the motion of tapping the MP lightly against another mobile phone. FIGS. 10(c₃) and 10(c₄) illustrate variations in the GUI in response to the ‘gentle bump’ motion.

Referring to FIGS. 10(c₃) and 10(c₄), a visual effect of the photo trying, but failing to be transferred to the other mobile phone may be displayed in the GUI. Accordingly, a user may intuitively recognize that the photo has failed to be transmitted to the other mobile phone.

Then, the user may naturally assume that a harder tap of the MP against the other mobile phone would successfully transmit the photo to the other mobile terminal.

Transmitting an image from the mobile terminal MP to another mobile terminal with a visual effect of the image being transferred from the mobile terminal MP to another mobile terminal may be a function corresponding to a ‘bump’ motion.

Therefore, in response to the MP being tapped hard against another mobile phone, the MP may perform the function corresponding to the ‘bump’ motion. On the other hand, in response to the mobile terminal MP being tapped lightly against another mobile terminal, the MP may provide a visual effect that helps the user to intuitively recognize the function corresponding to the ‘bump’ motion.

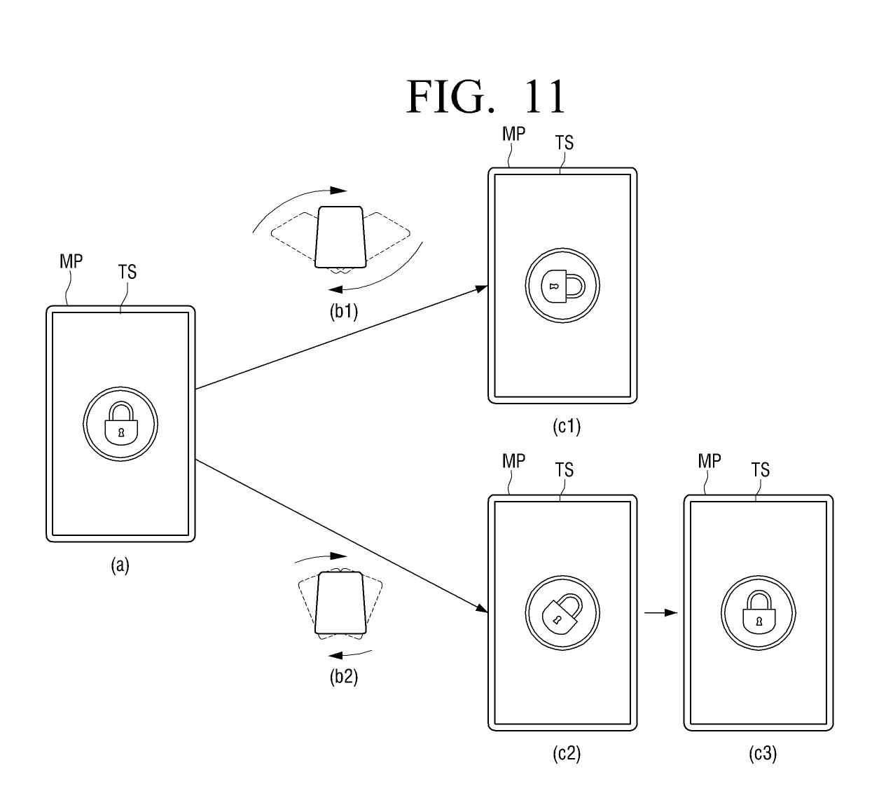

FIG. 11 illustrates a method of providing a UI according to a fifth embodiment of the present invention. FIG. 11(a) illustrates a MP with a touch screen that displays a GUI. Referring to FIG. 11(a), a hold icon is displayed in the GUI.

FIG. 11(b₁) illustrates a ‘hard spin’ motion, i.e., the motion of spinning the MP hard. FIG. 11(c₁) illustrates a variation in the GUI in response to the ‘hard spin’ motion.

Referring to FIG. 11(c₁), the GUI displays a rotated hold icon in response to the ‘hard spin’ motion, and the MP may be switched to a hold mode so that a user input to the TS may be ignored.

FIG. 11(b₂) illustrates a ‘gentle spin’ motion, i.e., the motion of spinning the MP gently. FIGS. 11(c₂) and 11(c₃) illustrate variations in the GUI in response to the ‘gentle spin’ motion.

Referring to FIGS. 11(c₂) and 11(c₃), a visual effect of the hold icon trying, but failing to be rotated may be displayed in the GUI. Accordingly, a user may intuitively recognize that the hold icon has failed to be rotated.

Then, the user may naturally assume that a harder spinning of the MP would successfully rotate the hold icon.

Switching the MP to the hold mode while maintaining the hold icon to be rotated may be a function corresponding to a ‘spin’ motion.

Therefore, in response to the MP being spun hard, the MP may perform the function corresponding to the ‘spin’ motion. On the other hand, in response to the mobile terminal MP being spun gently, the MP may provide a visual effect that helps the user to intuitively recognize the function corresponding to the ‘spin’ motion.

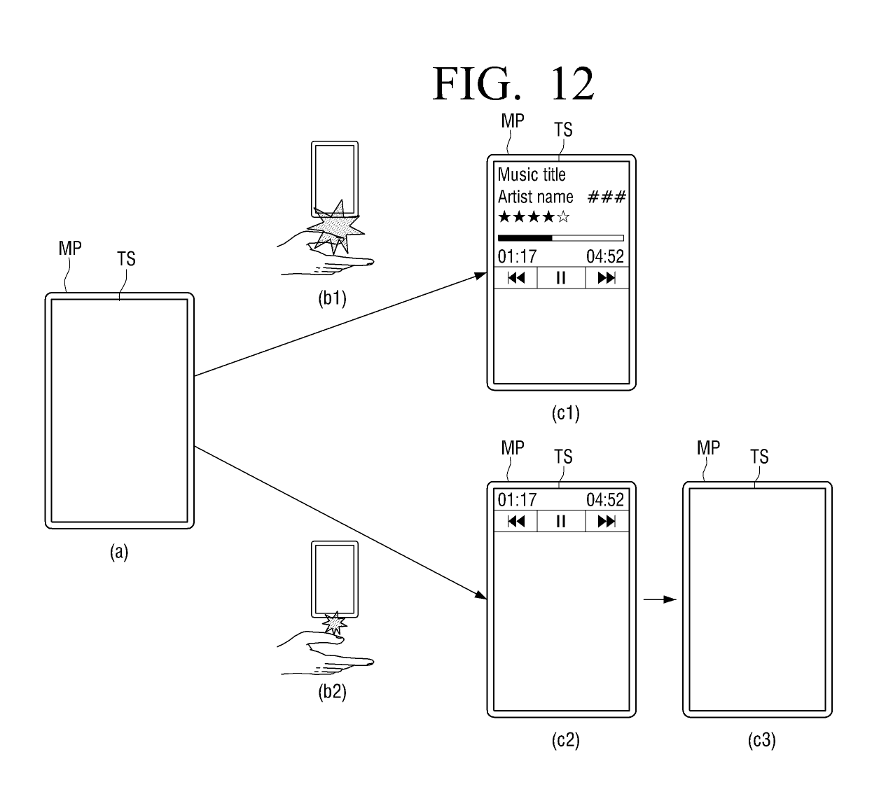

FIG. 12 illustrates a method of providing a UI according to a sixth embodiment of the present invention. FIG. 12(a) illustrates a MP with a TS that displays a GUI. Referring to FIG. 12(a), no controller is displayed in the GUI.

FIG. 12(b₁) illustrates a ‘hard tap’ motion, i.e., the motion of tapping the bottom of the MP hard with a hand. FIG. 12(c₁) illustrates a variation in the GUI in response to the ‘hard tap’ motion.

Referring to FIG. 12(c₁), the GUI displays a music player in response to the ‘hard tap’ motion. The music player may be configured to appear as if pulled down from the top of the TS.

FIG. 12(b₂) illustrates a ‘soft tap’ motion, i.e., the motion of tapping the bottom of the MP gently with a hand. FIGS. 12(c₂) and 12(c₃) illustrates variations in the GUI in response to the ‘soft tap’ motion.

Referring to FIGS. 12(c₂) and 12(c₃), a visual effect of the music player appearing briefly from the top of the TS and then readily receeding from the TS may be displayed in the GUI. Accordingly, a user may intuitively recognize that the music player has failed to be pulled down from the top of the TS.

Then, the user may naturally assume that a harder tap of the MP would successfully pull down the music player from the top of the TS.

Pulling down the music player from the top of the TS so as to be displayed on the TS may be a function corresponding to a ‘tap’ motion.

Therefore, in response to the bottom of the MP being tapped hard with a hand, the MP may perform the function corresponding to the ‘tap’ motion. On the other hand, in response to the bottom of the mobile terminal MP being tapped gently with a hand, the MP may provide a visual effect that helps the user to intuitively recognize the function corresponding to the ‘tap’ motion.

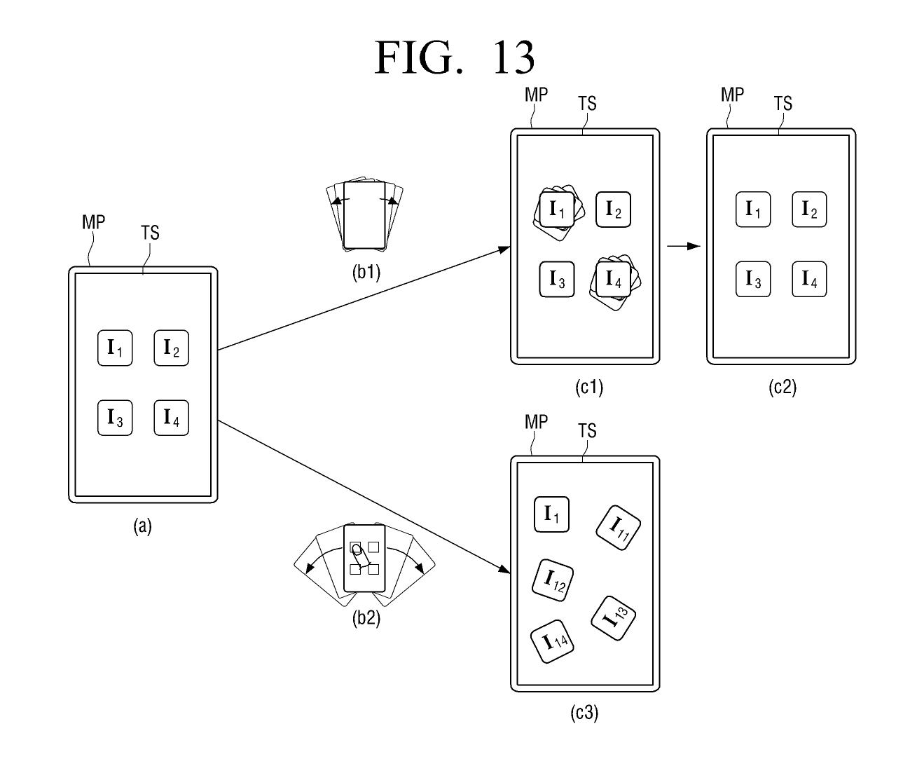

FIG. 13 illustrates a method of providing a UI according to a seventh embodiment of the present invention. FIG. 13(a) illustrates a MP with a TS that displays a GUI. Referring to FIG. 13(a), four icons I₁, I₂, I₃, and I₄ are displayed in the GUI.

FIG. 13(b₁) illustrates a ‘gentle shake’ motion, i.e., the motion of shaking the MP gently. FIGS. 13(c₁) and 13(c₂) illustrate variations in the GUI in response to the ‘gentle shake’ motion.

Referring to FIGS. 13(c₁) and 13(c₂), a visual effect of a plurality of sub-icons of the icon I₁ and a plurality of sub-icons of the icon I₄ appearing briefly from behind the icon I₁ and the icon I₄, respectively, and readily returning behind the icon I₁ and the icon I₄, respectively, is displayed in the GUI. Accordingly, a user may intuitively recognize the sub-icons of the icon I₁ and the sub-icons of the icon I₄ have failed to be removed from behind the icon I₁ and the icon I₄, respectively.

Then, the user may naturally assume that a stronger shake of the MP would successfully remove the sub-icons of the icon I₁ and the sub-icons of the icon I₄ from behind the icon I₁ and the icon I₄, respectively so that they may appear on the TS.

The user may also recognize that the icon I₂ and the icon I₃ do not have any sub-icons thereof.

FIG. 13(b₂) illustrates a ‘touch-and-shake-hard’ motion, i.e., the motion of shaking the MP while touching the icon I. FIG. 13(c₃) illustrates a variation in the GUI in response to the ‘touch-and-shake-hard’ motion.

Referring to FIG. 13(c₃), not only the icon I₁, which is being touched by the user, but also the sub-icons of the icon I₁ (i.e., sub-icons I₁₁, I₁₂, I₁₃, and I₁₄) may be displayed in the GUI. The sub-icons I₁₁, I₁₂, I₁₃, and I₁₄ may be displayed as being taken out from below the icon I.

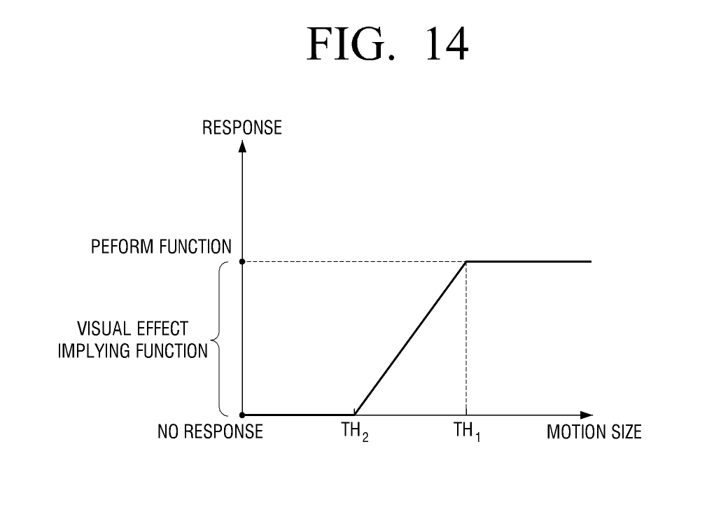

FIG. 14 is a diagram further explaining the first to seventh embodiments of FIGS. 7 to 13 by a graph showing how a mobile phone responds to motions of different sizes. Referring to FIG. 14, in a case in which the size of a motion is greater than a first threshold TH₁, a function mapped to the motion may be performed. In a case in which the size of the motion is greater than a second threshold TH₂ but is not greater than the first threshold TH₁, the function mapped to the motion may not be performed, and a visual effect that implies the function mapped to the motion may be output. In a case in which the size of the motion is not greater than the second threshold TH₂, the function mapped to the motion may not be performed, and the visual effect may not be output. That is, the mobile phone may not respond to the motion.

For example, the term ‘size of a motion’ indicates at least one of the parameters of the motion, i.e., the direction of the motion the speed of the motion, the degree of a shake (or a rotation) involved in the motion, and the width of the motion. The comparison of the size of a motion with a threshold may be performed by comparing the size of the motion with a threshold for at least one of the parameters of the motion. For example, a mobile phone may be configured to perform a function mapped to a motion in response to the speed of the motion exceeding a first threshold for speed or in response to the speed of the motion exceeding the first threshold for speed and the degree of a rotation involved in the motion exceeding a first threshold for rotation.

A visual effect may be configured to vary depending on the size of a motion. For example, the amount of the movement of an icon or an image involved in a visual effect may be configured to be proportional to the values of the parameters of a motion.

In the above embodiments, a visual effect that implies a function mapped to a motion may be provided in a case in which the motion is not large in size, but this is merely exemplary.

An audio effect or a tactile effect, instead of a visual effect, may be provided for a motion that is not large in size.

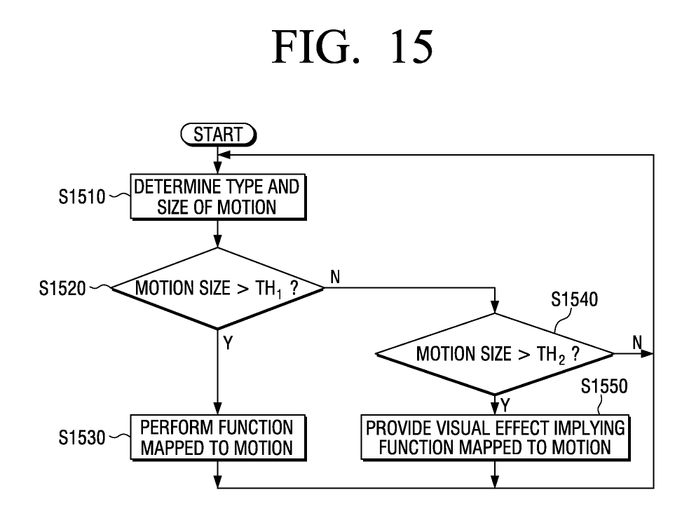

FIG. 15 is a flowchart illustrating a method of providing a UI according to another embodiment of the present invention.

Referring to FIG. 15, in response to the detection of the user's motion by the motion sensing unit 150, the control unit 130 may identify the type and size of the detected motion in Step 1510. The control unit 130 may compare the size of the detected motion with a first threshold TH₁ and, if less than the first threshold TH₁, a second threshold TH₂ in Steps 1520 and 1540, respectively.

If the size of the detected motion is determined to exceed the first threshold TH₁, the control unit 130 may control the function block 110 to perform a function mapped to the detected motion, and may change a GUI currently being displayed on the touch screen 120 in Step 1530.

If the size of the detected motion is determined not to exceed the first threshold

TH₁ but to exceed the second threshold TH₂ in Step 1650, the control unit 130 may output a visual effect that implies the function mapped to the detected motion via the touch screen 120.

If the size of the detected motion is determined not to exceed the second threshold TH₂, the control unit 130 may not respond to the detected motion and will return to Step 1510.

It will be apparent to those skilled in the art that various modifications and variation can be made in the present invention without departing from the spirit or scope of the invention. Thus, it is intended that the present invention cover modifications and variations of this invention within the scope of the appended claims and their equivalents.

1. A method of providing a User Interface (UI), the method comprising:
identifying a user motion; and
in response to a determination that the identified user motion coincides with one of a plurality of motions, performing a function mapped to the plurality of motions.

2. The method of claim 1, wherein performing the function comprises performing the mapped function while varying a visual effect that accompanies performing the mapped function.

3. The method of claim 2, wherein details of the visual effect are determined based on at least one of a plurality of parameters of the identified user motion.

4. The method of claim 3, wherein elements of the visual effect correspond to a value of the at least one parameter of the identified user motion.

5. The method of claim 2, wherein details of the visual effect are determined based on a content item to which the visual effect is to be applied or to a background displayed on the UI.

6. The method of claim 2, wherein the visual effect comprises an animation effect.

7. The method of claim 1, wherein a state of mapping the function and the plurality of motions varies from one application to another application.

8. The method of claim 1, wherein performing the function comprises varying at least one of an audio effect and a tactile effect that accompanies performing the function depending on a type of the identified user motion.

9. The method of claim 1, further comprising:
when a size of the identified user motion is determined to exceed a first threshold, performing the function; and
when the size of the identified user motion does not exceed the first threshold, outputting an effect relevant to the function, while not performing the function.

10. The method of claim 9, further comprising:
when a value of at least one of a plurality of parameters of the identified user motion exceeds a second threshold, determining whether a size of the identified motion exceeds the first threshold.

11. The method of claim 9, wherein the effect that is relevant to the function comprises a visual effect that helps the user intuitively recognize the function.

12. The method of claim 11, wherein outputting the effect comprises outputting different visual effects for motions of different sizes.

13. The method of claim 11, wherein outputting the effect comprises outputting the visual effect when the size of the identified user motion does not exceed the first threshold but exceeds the second threshold, which is less than the first threshold.

14. The method of claim 11, wherein, when multiple functions can be performed when the size of the identified user motion is determined to exceed the first threshold, the outputting comprises outputting visual effects that are relevant to multiple functions to be output together when the size of the identified user motions does not exceed the first threshold.

15. The method of claim 9, wherein, when multiple functions can be performed when the size of the identified user motion is determined to exceed the first threshold, the performing comprises performing a function that is selected by the user from among the multiple functions while making the identified motion, in response to determining that the size of the identified user motion exceeds the first threshold.

16. The method of claim 15, wherein the selected function corresponds to a function relevant to an icon selected by the user.

17. The method of claim 9, wherein the effect comprises at least one of an audio effect and a tactile effect.

18. A device comprising:
a sensing unit which senses a user motion; and
a control unit which, in response to a determination that the sensed user motion coincides with one of a plurality of motions, controls a function mapped to the plurality of motions.

19. The device of claim 18, wherein the control unit controls the mapped function to be performed while varying a visual effect displayed on the device that accompanies performing the function.

20. The device of claim 19, wherein details of the visual effect are determined based on at least one of a plurality of parameters of the sensed user motion.

21. The device of claim 20, wherein elements of the visual effect correspond to a value of the at least one parameter of the sensed user motion.

22. The device of claim 19, wherein details of the visual effect are determined based on a content item to which the visual effect is to be applied or to a displayed background.

23. The device of claim 19, wherein the visual effect comprises an animation effect.

24. The device of claim 18, wherein a state of mapping the function and the plurality of motions varies from one application to another application.

25. The device of claim 18, wherein the control unit controls the function to be performed while varying at least one of an audio effect and a tactile effect that is accompanies performing the function depending on a type of the sensed user motion.

26. The device of claim 18, wherein the control unit controls the function to be performed when a size of the sensed user motion exceeds a first threshold, and outputs an effect that is relevant to the function when the size of the sensed user motion is determined not to exceed the first threshold.

27. The device of claim 26, wherein the effect that is relevant to the function comprises a visual effect that helps the user intuitively recognize the function.

28. The device of claim 27, wherein the control unit controls different visual effects to be output for motions of different sizes.

29. The device of claim 28, wherein the visual effects include a movement that is proportional to a size of the sensed motion.

30. The device of claim 27, wherein, when multiple functions can be performed when the size of the sensed user motion exceeds the first threshold, the control unit controls visual effects that are relevant to multiple functions to be output together when the size of the sensed user motion does not exceed the first threshold.

31. The device of claim 26, wherein, when multiple functions can be performed when the size of the sensed user motion exceeds the first threshold, the control unit controls a function that is selected by the user from among the multiple functions while making the sensed motion, when the size of the sensed user motion exceeds the first threshold.
